(19) United States
(12) Patent Application Publication
(10) Pub. No.: US 2024/0357298 A1
(43) Pub. Date: Oct. 24, 2024

(54) COUPLER FOR BONE CONDUCTION HEARING PROSTHESIS

(71) Applicant: Cochlear Limited, Macquarie University, NSW (AU)

(72) Inventors: Marcus Vardfjäll, Askim (SE); Stefan Magnander, Göteborg (SE); Tommy Bergs, Härryda (SE)

(21) Appl. No.: 18/290,971

(22) PCT Filed: Aug. 8, 2022
(86) PCT No.: PCT/IB2022/057378

§ 371 Date: Jan. 22, 2024

Related U.S. Application Data
(60) Provisional application No. 63/268,768, filed on Mar. 2, 2022.
(60) Provisional application No. 63/235,943, filed on Aug. 23, 2021.

(51) Int. Cl. H04R 25/00

(52) U.S. Cl. CPC H04R 25/606; H04R 2460/13

(57) ABSTRACT

An apparatus includes a coupling portion configured to be releasably coupled to an abutment affixed to a recipient's body. The coupling portion includes a substantially cylindrically symmetric body portion extending along a symmetry axis, the body portion including an outer body surface having a recess extending around the symmetry axis. The coupling portion further includes a resilient member in the recess and extending around the symmetry axis. The resilient member extends outwardly past the outer body surface and is configured to contact an inner abutment surface of the abutment. The resilient member is configured to undergo compression by the inner abutment surface and an inner surface of the recess upon being releasably coupled to the abutment. The compression has a component substantially perpendicular to the symmetry axis.

### BACKGROUND

### Field

The present application relates generally to systems and methods for releasably coupling an external portion of a medical device system to an implanted portion affixed to a recipient's body.

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises a coupling portion configured to be releasably coupled to an abutment affixed to a recipient's body. The coupling portion comprises a substantially cylindrically symmetric body portion extending along a symmetry axis, the body portion comprising an outer body surface having a recess extending around the symmetry axis. The coupling portion further comprises a resilient member in the recess and extending around the symmetry axis. The resilient member extends outwardly past the outer body surface and is configured to contact an inner abutment surface of the abutment. The resilient member is configured to undergo compression by the inner abutment surface and an inner surface of the recess upon being releasably coupled to the abutment. The compression has a component substantially perpendicular to the symmetry axis.

In another aspect disclosed herein, an apparatus comprises a rigid body portion having a center axis and configured to be releasably attached to an abutment affixed to a recipient's body by moving the rigid body portion along the center axis towards the recipient's body. The rigid body portion or the abutment comprises a channel completely encircling the center axis. The apparatus further comprises an elastically compressible element in the channel and completely encircling the center axis. The elastically compressible element is configured to, upon the rigid body portion being releasably attached to the abutment, apply forces having substantially radial force components to both the rigid body portion and the abutment.

In another aspect disclosed herein, a method comprises attaching a device to an abutment affixed to a recipient's body by moving the device along a first direction towards the abutment such that a ring-shaped elastically compressible member is compressed between an inner perimeter of the ring-shaped elastically compressible member and an outer perimeter of the ring-shaped elastically compressible member. The method further comprises detaching the device from the abutment without damaging the device and/or the abutment.

### BRIEF DESCRIPTION OF THE DRAWINGS

Implementations are described herein in conjunction with the accompanying drawings, in which:

FIG. 1A schematically illustrates a portion of an example percutaneous bone conduction device implanted in a recipient in accordance with certain implementations described herein:

FIG. 1B is a functional block diagram of an example percutaneous bone conduction auditory prosthesis in accordance with certain implementations described herein;

FIG. 1C depicts a side view of a portion of an example percutaneous bone conduction device in accordance with certain implementations described herein;

FIG. 2 schematically illustrates a cross-sectional view of a portion of an example apparatus in accordance with certain implementations described herein;

FIG. 3A is a perspective view of an example coupling portion in accordance with certain implementations described herein;

FIGS. 3B-3D are side views of the example coupling portion of FIG. 3A during an example process of being releasably coupled to an example abutment in accordance with certain implementations described herein;

FIGS. 4A-4C schematically illustrate various cross-sectional views of an example apparatus in accordance with certain implementations described herein; and

FIG. 5 is a flow diagram of an example method in accordance with certain implementations described herein.

### DETAILED DESCRIPTION

Certain implementations described herein provide a mechanical coupler between an external device and an abutment implanted on or within a recipient's body. The coupler can comprise a flexible ring (e.g., garter spring; C-clip; O-ring) that is part of the external device or an external portion of the abutment and is compressed upon the external device being mated with (e.g., snapped onto; latched onto) the abutment. The mechanical coupler can be more easily fabricated than other couplers (e.g., fewer parts; more robust; less manufacturing variation; less wear) and/or can be more space efficient (e.g., smaller distance between the external device and the recipient's body) than other couplers. The mechanical coupler can also avoid using thread locking to mate the mechanical coupler to the external device and/or can provide shock protection by detaching from the abutment in response to unexpected impacts or other forces without damage to the device and/or the abutment.

The teachings detailed herein are applicable, in at least some implementations, to any type of implantable or non-implantable vibration stimulation system or device (e.g., implantable or non-implantable bone conduction auditory prosthesis device or system). Implementations can include any type of medical device that can utilize the teachings detailed herein and/or variations thereof. Furthermore, while certain implementations are described herein in the context of auditory prosthesis devices, certain other implementations are compatible in the context of other types of devices or systems (e.g., bone conduction headphones; bone conduction speakers; bone conduction microphones; ultrasonic imaging).

Merely for ease of description, apparatus and methods disclosed herein are primarily described with reference to illustrative medical systems, namely active transcutaneous or percutaneous bone conduction auditory prosthesis systems. However, the teachings detailed herein and/or variations thereof may also be used with a variety of other medical or non-medical systems that provide a wide range of therapeutic benefits to recipients, patients, or other users. In some implementations, the teachings detailed herein and/or variations thereof can be utilized in other types of devices beyond auditory prostheses that may benefit from improvement of hearing percepts at vibrational frequency ranges generated by electromagnetic transducers and piezoelectric transducers. Implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses. In some implementations, the teachings detailed herein and/or variations thereof can be utilized in other types of prostheses beyond auditory prostheses.

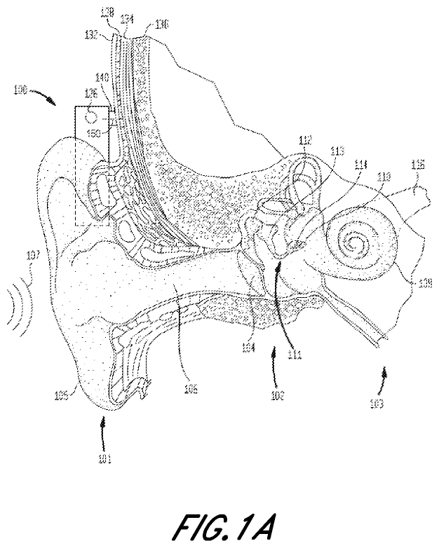

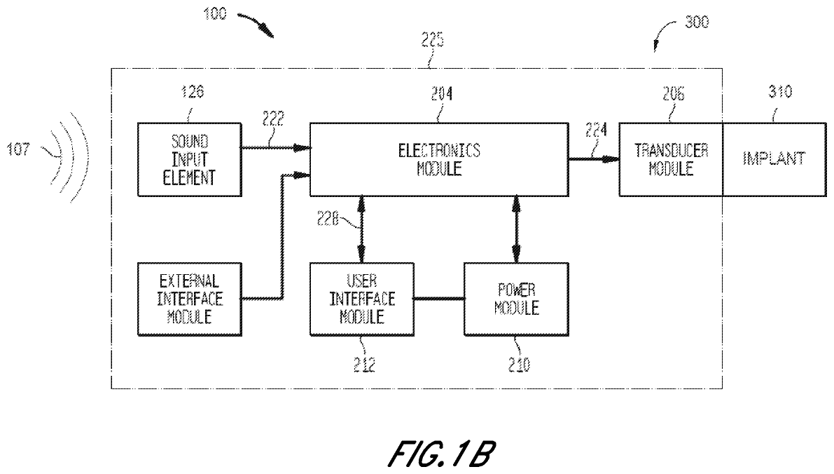

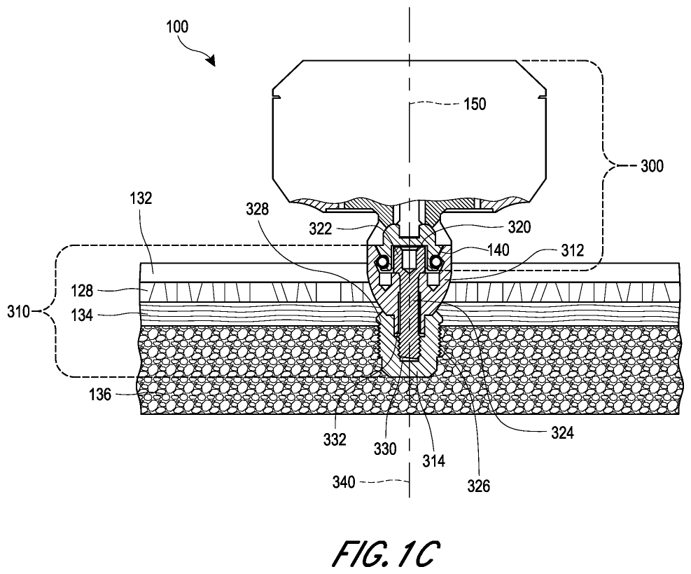

FIG. 1A schematically illustrates a perspective view of a portion of an example percutaneous bone conduction device 100 (e.g., auditory prosthesis) implanted in a recipient in accordance with certain implementations described herein. FIG. 1B is a functional block diagram of an example percutaneous bone conduction device 100 in accordance with certain implementations described herein. FIG. 1C schematically illustrates a side view of a portion of an example percutaneous bone conduction implant 310 in accordance with certain implementations described herein configured to be coupled to an operationally removable component 300 of the percutaneous bone conduction device 100.

As shown in FIG. 1A, the recipient has an outer ear 101, a middle ear 102, and an inner ear 103. Elements of the outer ear 101, the middle ear 102, and the inner ear 103 are described below, followed by a description of the auditory prosthesis 100. In a fully functional human hearing anatomy, the outer ear 101 comprises an auricle 105 and an ear canal 106. A sound wave or acoustic pressure 107 is collected by the auricle 105 and channeled into and through the ear canal 106. Disposed across the distal end of the ear canal 106 is a tympanic membrane 104 which vibrates in response to the acoustic wave 107. This vibration is coupled to the oval window or fenestra ovalis 110 through three bones of the middle ear 102, collectively referred to as the ossicles 111 and comprising the malleus 112, the incus 113, and the stapes 114. The ossicles 111 of the middle ear 102 serve to filter and amplify the acoustic wave 107, causing the oval window 110 to vibrate. Such vibrations set up waves of fluid motion within the cochlea 139. Such fluid motion, in turn, activates hair cells (not shown) that line the inside of the cochlea 139. Activation of the hair cells causes appropriate nerve impulses to be transferred through the spiral ganglion cells and the auditory nerve 116 to the brain (not shown), where they are perceived as sound.

FIG. 1A also illustrates an example positioning of the device 100 relative to the outer ear 101, the middle ear 102, and the inner ear 103 of a recipient of the device 100. As shown in FIG. 1A, the device 100 is positioned behind the outer ear 101 of the recipient and comprises a sound input element 126 to receive sound signals 107. The sound input element 126 can comprise, for example, a microphone, telecoil, etc. and can be located, for example, on or in the device 100, or on a cable extending from the device 100.

In certain implementations, the device 100 comprises an operationally removable component 300 and a bone conduction implant 310, as schematically illustrated by FIG. 1C. The operationally removable component 300 is operationally releasably coupled to the bone conduction implant 310. By operationally releasably coupled, it is meant that it is releasable in such a manner that the recipient can relatively easily attach and remove the operationally removable component 300 during normal use of the device 100, repeatedly if desired. Such releasable coupling is accomplished via a coupling apparatus of the operationally removable component 300 and a corresponding mating apparatus of the bone conduction implant 310, as will be detailed below. This operationally releasable coupling is contrasted with how the bone conduction implant 310 is attached to the skull, as will also be detailed below.

The operationally removable component 300 includes the sound input element 126, a sound processor (e.g., an electronics module 204 as shown in FIG. 1B), and an actuator 206 (e.g., a transducer module, as shown in FIG. 1B) configured to generate acoustic vibrations. The actuator 206 can comprise a vibrator (e.g., a vibrating electromagnetic actuator; a vibrating piezoelectric actuator; other type of vibrating actuator), and the operationally removable component 300 is sometimes referred to herein as a vibrator unit. More particularly, the sound input element 126 (e.g., a microphone) converts received sound signals 107 into electrical signals 222. Alternatively, sound signals 107 are received by the sound input element 126 as electrical signals (e.g., via a cable or wireless connection, such as from an audiovisual device). The electrical signals 222 from the sound input element 126 are processed by the electronics module 204, which can include a sound processing circuit, control electronics, transducer drive components, and a variety of other elements.

The electronics module 204 is configured to respond to the electrical signals 222 by generating control signals 224 which cause the actuator 206 to vibrate, generating a mechanical output force in the form of acoustic vibrations that is delivered to the skull of the recipient via the bone conduction implant 310. In other words, the operationally removable component 300 converts the received sound signals 107 into mechanical motion using the actuator 206 to impart vibrations to the recipient's skull. Delivery of this output force causes motion or vibration of the recipient's skull, thereby activating the hair cells in the recipient's cochlea 139 via cochlea fluid motion.

As shown in FIG. 1B, the operationally removable component 300 can further comprise a power module 210 configured to provide electrical power to one or more components of the device 100. For ease of illustration, the power module 210 has been shown connected only to user interface module 212 and the electronics module 204. However, it should be appreciated that the power module 210 can be used to supply power to any electrically powered circuits/components of the device 100. The user interface module 212 is configured to allow the recipient to interact with the device 100. For example, the user interface module 212 can allow the recipient to adjust the volume, alter the speech processing strategies, power on/off the device, etc. In the example of FIG. 1B, the user interface module 212 communicates with the electronics module 204 via the signal line 228. The device 100 of certain implementations further includes an external interface module 214 configured to connect the electronics module 204 to an external device, such as a fitting system. Using the external interface module 214, the operationally removable component 300 can obtain information from the device 100 (e.g., the current parameters, data, alarms, etc.) and/or modify the parameters of the device 100 used in processing received sounds and/or performing other functions.

In the example of FIG. 1B, the sound input element 126, the electronics module 204, the actuator 206 (e.g., transducer module), the power module 210, the user interface module 212, and the external interface module 214 have been shown as integrated in a single housing 225. However, it should be appreciated that in certain examples, one or more of the illustrated components can be housed in separate or different housings. For example, in some implementations, the actuator 206 and the sound input element 126 are housed in separate housings to eliminate a potential pathway for feedback. The sound input element 126, the electronics module 204, the power module 210, the user interface module 212, and the external interface module 214 can be housed in a behind-the-ear (BTE) component that is suspended from the pinna (e.g., by an ear hook). Similarly, it should also be appreciated that in certain such implementations, direct connections between the various modules and devices are not necessary and that the components can communicate, for example, via wireless connections.

As schematically illustrated in FIG. 1A, the operationally removable component 300 of the device 100 further includes a coupling apparatus 140 configured to operationally removably attach the operationally removable component 300 to a bone conduction implant 310 (also referred to as an anchor system and/or a fixation system) which is implanted in the recipient. In the example device 100 of FIG. 1A, the coupling apparatus 140 has a longitudinal axis 150 and is coupled to the bone conduction implant 310 (not shown in FIG. 1A).

FIG. 1C depicts a side view of a portion of an example percutaneous bone conduction implant 310 in accordance with certain implementations described herein. The example implant 310 of FIG. 1C comprises a percutaneous abutment 312, a bone fixture 314 (hereinafter sometimes referred to as the fixture 314), and an abutment screw 320. While FIG. 1C illustrates one example implant 310 in accordance with certain implementations described herein, other implants 310 (e.g., comprising abutments 312, fixtures 314, and/or abutment screws 320 of any type, size/having any geometry) are also compatible with certain implementations described herein.

The implant 310 is configured to be repeatedly coupled to and decoupled from the coupling apparatus 140 of the operationally removable component 300, as shown in FIG. 1C. The coupling apparatus 140 comprises a longitudinal axis 150 (e.g., an axis along a length of the coupling apparatus 140; an axis about which the coupling apparatus 140 is at least partially symmetric). For example, the coupling apparatus 140 can be configured to be removably attached to the bone conduction implant 310 by pressing the coupling apparatus 140 against the abutment 312 in a direction along (e.g., substantially parallel to) the longitudinal axis 150 of the coupling apparatus 140 and/or along (e.g., substantially parallel to) the longitudinal axis 340 of the abutment 312. In certain such implementations, the coupling apparatus 140 can be configured to be snap-coupled to the abutment 312. In certain implementations, as depicted by FIG. 1C, the coupling apparatus 140 comprises a male component and the abutment 312 comprises a female component configured to mate with the male component of the coupling apparatus 140. In certain implementations, this configuration can be reversed, with the coupling apparatus 140 comprises a female component and the abutment 312 comprises a male component configured to mate with the female component of the coupling apparatus 140.

The operationally removable component 300 comprises the actuator 206, with the operationally removable component 300 vibrationally connected to and removably coupled to the implant 310 via the coupling apparatus 140. More particularly, the actuator 206 of the operationally removable component 300 is in vibrational communication with the coupling apparatus 140 such that vibrations generated by the actuator 206, in response to a sound captured by the sound input element 126, are transmitted to the coupling apparatus 140 and then to the implant 310 in a manner that at least effectively evokes a hearing percept. By “effectively evokes a hearing percept,” it is meant that the vibrations are such that a typical human between 18 years old and 40 years old having a fully functioning cochlea receiving such vibrations, where the vibrations communicate speech, would be able to understand the speech communicated by those vibrations in a manner sufficient to carry on a conversation provided that those adult humans are fluent in the language forming the basis of the speech. In certain implementations, the vibrational communication effectively evokes a hearing percept, if not a functionally utilitarian hearing percept.

The abutment 312 of certain implementations is symmetrical with respect to at least those portions of the abutment 312 above the top portion of the fixture 314. For example, the exterior surfaces of the abutment 312 can form concentric outer profiles about a longitudinal axis 340 of the abutment 312 (e.g., an axis along a length of the abutment 312; an axis about which the abutment 312 is at least partially symmetric). As shown in FIG. 1C, the exterior surfaces of the abutment 312 establish diameters lying on planes normal to the longitudinal axis 340 that vary along the length of the longitudinal axis 340. For example, the abutment 312 can include outer diameters that progressively become larger with increased distance from the fixture 314. In certain other implementations, the outer diameters can have other outer profiles.

In certain implementations, the abutment 312 is configured for integration between the skin and the abutment 312. Integration between the skin and the abutment 312 can be considered to occur when the soft tissue of the skin 132 encapsulates the abutment 312 in fibrous tissue and does not readily dissociate itself from the abutment 312. This too inhibits the entrapment and/or growth of microbes proximate the implant 310. For example, the abutment 312 can have a surface having features which are configured to reduce certain adverse skin reactions. In certain implementations, the abutment 312 is coated to reduce the shear modulus, which can also encourage skin integration with the abutment 213. For example, at least a portion of the abutment 312 can be coated with or otherwise contain a layer of hydroxyapatite that enhances the integration of skin with the abutment 312.

The abutment 312 is configured to be attached to the fixture 314 via the abutment screw 320, and the fixture 314 is configured to be fixed to (e.g., screwed into) the recipient's skull bone 136. The abutment 312 is affixed to the bone fixture 314 and extends from the fixture 314, through muscle 134, fat 128, and skin 132 so that the coupling apparatus 140 can be attached thereto. The abutment screw 320 (e.g., comprising a screw head 322 and an elongate coupling shaft 324 connected to the screw head 322) connects and holds the abutment 312 to the fixture 314, thereby rigidly attaching the abutment 312 to the fixture 314. The rigid attachment is such that the abutment 312 is vibrationally connected to the fixture 314 such that at least some of the vibrational energy transmitted to the abutment 312 is transmitted to the fixture 314 in a sufficient manner to effectively evoke a hearing percept. The percutaneous abutment 312 provides an attachment location for the coupling apparatus 140 that facilitates efficient transmission of mechanical force.

The fixture 314 can be made of any material that has a known ability to integrate into surrounding bone tissue (e.g., comprising a material that exhibits acceptable osseointegration characteristics). In certain implementations, the fixture 314 is formed from a single piece of material (e.g., titanium) and comprises outer screw threads 326 forming a male screw which is configured to be installed into the skull bone 136 and a flange 328 configured to function as a stop when the fixture 314 is implanted into the skull bone 136. The screw threads 326 have can have a maximum diameter of about 3.5 mm to about 5.0 mm, and the flange 328 can have a diameter which exceeds the maximum diameter of the screw threads 326 (e.g., by approximately 10%-20%). The flange 328 has a planar bottom surface for resting against the outer bone surface, when the fixture 314 has been screwed down into the skull bone 136. The flange 328 prevents the fixture 314 in general, and, in particular, screw threads 326, from potentially completely penetrating completely through the bone 136.

The body of the fixture 314 can have a length sufficient to securely anchor the fixture 314 to the skull bone 136 without penetrating entirely through the skull bone 136. The length of the body can therefore depend on the thickness of the skull bone 136 at the implantation site. For example, the fixture 314 can have a length, measured from the planar bottom surface of the flange 328 to the end of the distal region (e.g., the portion farthest from the flange 328), that is no greater than 5 mm or between about 3.0 mm to about 5.0 mm, which limits and/or prevents the possibility that the fixture 314 might go completely through the skull bond 136.

The interior of the fixture 314 further includes an inner lower bore 330 having female screw threads configured to mate with male screw threads of the elongate coupling shaft 324 to secure the abutment screw 320 and the abutment 312 to the fixture 314. The fixture 314 further includes an inner upper bore 332 that receives a bottom portion of the abutment 312. While FIG. 1C shows the coupling apparatus 140 directly engaging with (e.g., directly contacting) the abutment screw 320 (e.g., the screw head 322), in certain other implementations, the coupling apparatus 140 engages with the abutment 312 without directly engaging with (e.g., without directly contacting) the abutment screw 320.

In certain implementations, the bottom of the abutment 312 includes a fixture connection section extending below a reference plane extending across the top of the fixture 314 and that interfaces with the fixture 314. Upon sufficient tensioning of the abutment screw 320, the abutment 312 sufficiently elastically and/or plastically stresses the fixture 314, and/or visa-versa, so as to form a tight seal at the interface of surfaces of the abutment 312 and the fixture 314. Certain such implementations can reduce (e.g., eliminate) the chances of micro-leakage of microbes into the gaps between the abutment 312, the fixture 314 and the abutment screw 320.

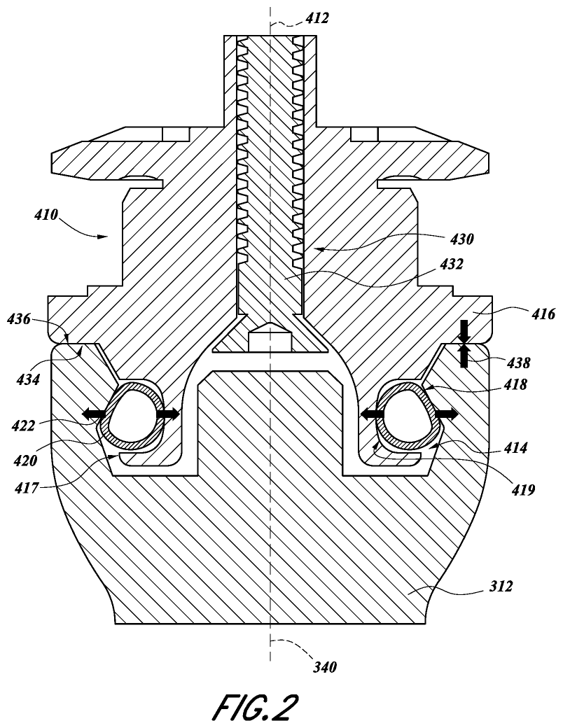

FIG. 2 schematically illustrates a cross-sectional view of a portion of an example apparatus 400 (e.g., coupling apparatus 140; operationally removable component 300) in accordance with certain implementations described herein. The apparatus 400 comprises a coupling portion 410 having a center axis 412 (e.g., longitudinal axis 150) and configured to be releasably attached to an abutment 312 affixed to a recipient's body (e.g., reversibly affixed to and detached from the abutment 312) by moving the coupling portion 410 along the center axis 412 towards the recipient's body. The coupling portion 410 comprises a recess 414 (e.g., channel) extending around (e.g., completely encircling) the center axis 412. The apparatus 400 further comprises a resilient (e.g., elastically compressible) element 420 in the recess 414 and extending around (e.g., completely encircling) the center axis 412. The resilient element 420 is configured to, upon the coupling portion 410 being releasably attached to the abutment 312, apply forces having substantially radial force components 422 to both the coupling portion 410 and the abutment 312.

In certain implementations, the coupling portion 410 comprises a rigid body 416 having an outer body surface 417. In certain implementations, the coupling portion 410 comprises a solid material (e.g., metal; plastic such as polyether ether ketone or PEEK) that is in mechanical communication with an actuator 206 (e.g., transducer; sensor) of the operationally removable component 300. For example, as schematically illustrated by FIG. 2, the coupling portion 410 comprises at least one through hole 430 and is attached to the actuator 206 by at least one screw 432. In certain implementations, the coupling portion 410 is a unitary (e.g., single; monolithic) component, while in certain other implementations, the coupling portion 410 comprises two or more separate components that can be assembled together (e.g., affixed to one another; screwed into one another) to form the coupling portion 410.

In certain implementations, the resilient element 420 comprises a garter spring comprising a wire (e.g., metal; carbon steel; stainless steel) coiled around a coil axis, the coil axis substantially planar and surrounding a center axis that is substantially perpendicular to the coil axis. Example garter springs compatible with certain implementations described herein are available from Bal-Seal Engineering of Foothill Ranch, California. In certain other implementations, the resilient element 420 comprises a C-clip (e.g., a substantially planar circular ring having a substantially incompressible cross-section and two ends spaced from one another with an opening therebetween) that is elastically expandable and/or compressible to change the overall diameter of the C-clip. In certain other implementations, the resilient element 420 comprises an O-ring comprising an elastically compressible material (e.g., elastomer; rubber; Viton™ fluoroelastomer). In certain implementations, the resilient element 420 can be ring-shaped (e.g., substantially circular, oval, polygonal, symmetric, non-symmetric, or non-regular) in a plane perpendicular to the center axis 412. For example, the resilient element 420 can be ring-shaped and substantially circular with an inner diameter in a range of 2 millimeters to 5 millimeters, an outer diameter in a range of 3 millimeters to 7 millimeters, and a width between the inner diameter and outer diameter in a range of less than 1 millimeter (e.g., 0.7 millimeter; 0.8 millimeter).

In certain implementations in which the effects of moisture, grease, or other materials potentially affecting the coupling between the coupling portion 410 and the abutment 312 are a concern, a metal garter spring (e.g., steel) and a metal abutment 312 (e.g., titanium) can be used to provide a metal-to-metal contact that not significantly affected by such effects. In other implementations in which wear between a metal garter spring and a metal abutment from repeated attachment and detachment and/or particles interfering with the coils of the garter spring are concerns, an O-ring can be used with the metal abutment 312 to inhibit such effects.

In certain implementations, as schematically illustrated by FIG. 2, the resilient element 420 is in the recess 414, extends outwardly past the outer body surface 417, and is configured to contact an inner abutment surface 418 of the abutment 312. The resilient element 420 is configured to undergo compression by the inner abutment surface 418 and an inner recess surface 419 of the recess 414 upon being releasably coupled to the abutment 312, the compression having a component substantially perpendicular to the center axis 412 (e.g., the compressive force having a component equal and opposite to the substantially radial force components 422 denoted in FIG. 2). In certain implementations in which the resilient element 420 comprises a garter spring, the compression of the resilient element 420 can comprise an elastic bending of the spring coils such that the spring coils are canted to reduce the outer diameter of the garter spring and/or an elastic deformation of the coils (e.g., from their substantially circular shape) to reduce the outer diameter of the garter spring. While FIG. 2 schematically illustrates the coupling portion 410 comprising the recess 414 and the resilient element 420, in certain other implementations, the abutment 312 comprises the recess 414 and the resilient element 420, and the resilient element 420 is configured to undergo compression by respective surfaces of the abutment 312 and the coupling portion 410, the compression having a component substantially perpendicular to the center axis 412. In certain implementations, the coupling portion 410 and the abutment 312 are configured to be snap-coupled (e.g., latched; mated) to one another.

In certain implementations, the center axis 412 is a symmetry axis of the rigid body 416 of the coupling portion 410 and the rigid body 416 extends along and is substantially cylindrically symmetric about the center axis 412. For example, the coupling portion 410 (e.g., the rigid body 416, the recess 414, and the resilient element 420) can be substantially circularly symmetric about the center axis 412 (e.g., have a circular cross-sectional shape in a plane perpendicular to the center axis 412) and the abutment 312 can be substantially circularly symmetric about a center axis of the abutment 312. In certain such implementations, the coupling portion 410 can be coupled to the abutment 312 with any rotational orientation about the center axis 412 and/or the apparatus 400 can be rotated around the center axis 412 relative to the abutment 312 while the coupling portion 410 is releasably coupled to the abutment 312.

The coupling portion 410 and the abutment 312 of other certain implementations have other cross-sectional shapes (e.g., oval; polygonal) in a plane perpendicular to the center axis 412, such that the apparatus 400 and the abutment 312 can only be releasably coupled to one another with a finite number of rotational orientations about the center axis 412 (e.g., one, two, or more). The coupling portion 410 and the abutment 312 of still other certain implementations have non-symmetry or non-regular shapes (e.g., keyed) in a plane perpendicular to the center axis 412 such that the apparatus 400 and the abutment 312 can only be releasably coupled to one another with a single rotational orientation about the center axis 412. Certain implementations with a finite number of rotational orientations (e.g., a single rotational orientation) between the apparatus 400 and the abutment 312 inhibit (e.g., prevent) rotation of the apparatus 400 about the center axis 412 relative to the abutment 312 while the coupling portion 410 is releasably coupled to the abutment 312.

In certain implementations, the coupling portion 410 is sufficiently rigid to provide a pathway for vibration propagation between the actuator 206 and the recipient's body. For example, the coupling portion 410 can comprise a first rigid surface 434 configured to contact and be in mechanical communication with a corresponding second rigid surface 436 of the abutment 312 when the coupling portion 410 is releasably coupled to the abutment 312.

In certain implementations, the coupling portion 410 is sufficiently rigid such that the inner recess surface 419 does not appreciably deflect or deform relative to the inner abutment surface 418 while the coupling portion 410 is releasably coupled to the abutment 312 (e.g., such that the compression of the resilient element 420 is not substantially reduced or inhibited by movement of the inner recess surface 419).

In certain implementations in which the actuator 206 generates the vibrations, the vibrations transmitted by the apparatus 300 are within a range of vibrational frequencies that are perceptible by the recipient as sound (e.g., a range of 20 Hz to 20 kHz), which are referred to herein as auditory vibrations. These auditory vibrations propagate along the transmission path comprising the first and second rigid surfaces 434, 436 to the bone fixture 314 and propagate via bone conduction from the bone fixture 314 to an inner ear region (e.g., within the temporal bone and comprising the vestibule, the cochlea 139, and the semicircular canals) and/or a middle ear region (e.g., within the recipient's head, partially bounded by the tympanic membrane and comprising the ossicles 111, the round window, the oval window 110, and the Eustachian tube) to be detected as sound.

In certain implementations, the shape and/or orientation of the resilient element 420, the rigid body 416, and the abutment 312 are configured such that the compression of the resilient element 420 between the rigid body 416 and the abutment 312 generates forces on the rigid body 416 and the abutment 312 having first force components (e.g., substantially radial force components 422) that are substantially perpendicular to the center axis 412 and second force components 438 that are substantially parallel to the center axis 412. For example, as schematically illustrated by FIG. 2, the inner abutment surface 418 and the inner recess surface 419 are configured such that compression of the resilient element 420 between the inner abutment surface 418 and the inner recess surface 419 generates the substantially radial force components 422 that are substantially perpendicular to the center axis 412 and that press the resilient element 420 against the inner abutment surface 418 and the inner recess surface 419. These substantially radial force components 422 can substantially hold the apparatus 400 in place relative to the abutment 312.

In certain implementations, the inner abutment surface 418 and the inner recess surface 419 are further configured such that compression of the resilient element 420 between the inner abutment surface 418 and the inner recess surface 419 also generates the second force components 438 that press the first rigid surface 434 against the second rigid surface 436 (e.g., press the first and second rigid surface 434, 436 together such that the first and second rigid surfaces 434, 436 provide a portion of a propagation path for vibrations between the actuator 206 and the recipient's body). For example, for an apparatus 400 comprising an actuator 206 (e.g., transducer) configured to generate vibrations (e.g., vibrational energy), the first and second rigid surfaces 434, 436 can be configured to provide a portion of a transmission path for the vibrations from the actuator 206 to the recipient's body (e.g., via the fixture 314).

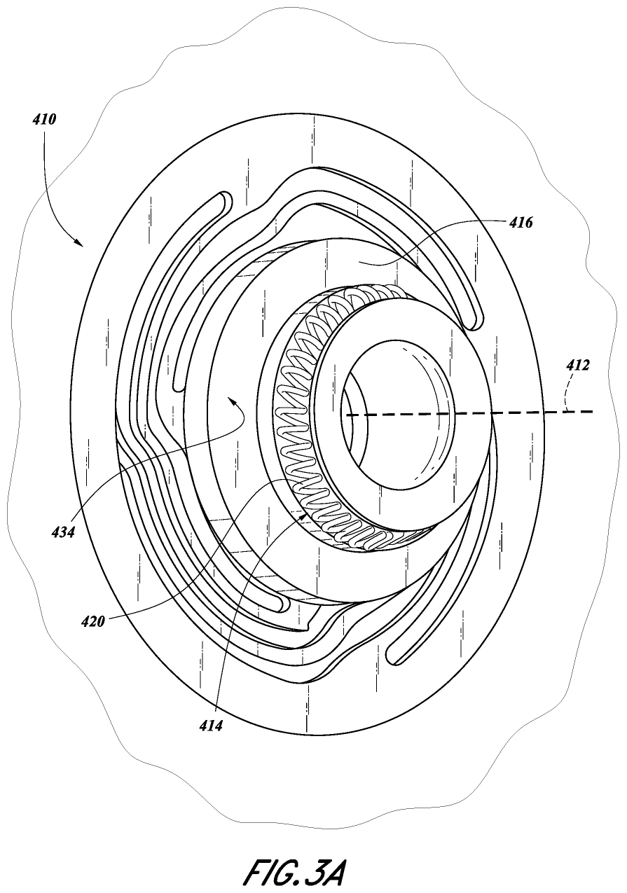

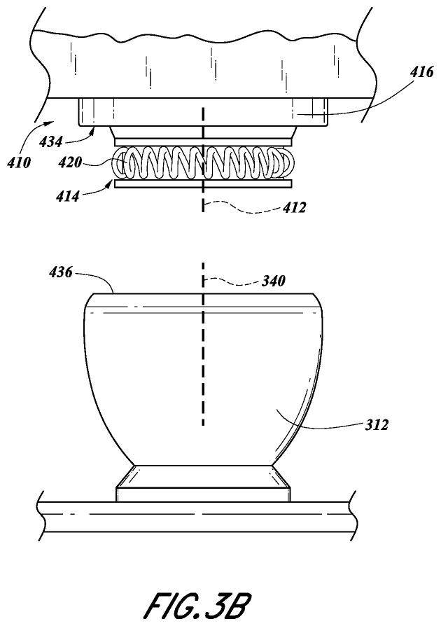

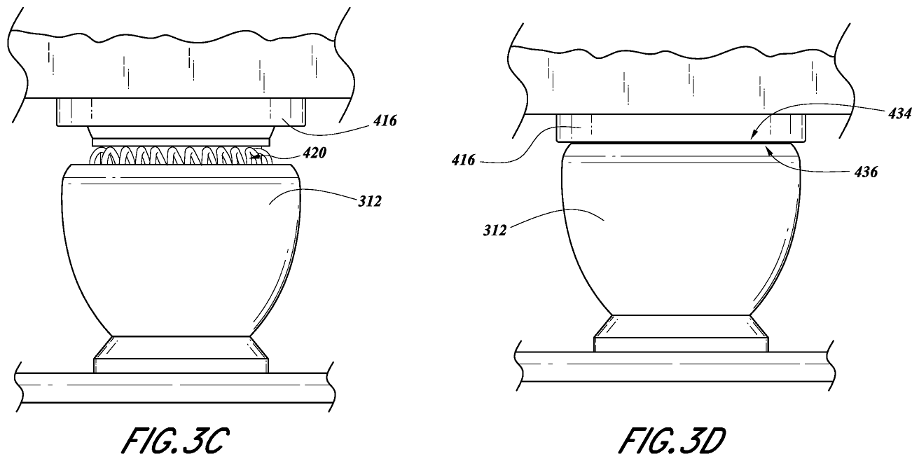

FIG. 3A is a perspective view of an example coupling portion 410 in accordance with certain implementations described herein. FIGS. 3B-3D are side views of the example coupling portion 410 of FIG. 3A during an example process of being releasably coupled to an example abutment 312 in accordance with certain implementations described herein. The example coupling portion 410 of FIG. 3A comprises a resilient element 420 comprising a garter spring in a recess 414 of the rigid body 416, the garter spring and the recess 414 extending around a center axis 412 of the coupling portion 410 (e.g., around a longitudinal symmetry axis of the rigid body 416).

In certain implementations, the apparatus 400 and the abutment 312, initially separate from one another, can be coupled to one another by aligning the center axis 412 of the coupling portion 410 with the longitudinal axis 340 of the abutment 312, as schematically illustrated by FIG. 3B. Coupling the apparatus 400 and the abutment 312 to one another can further comprise moving the coupling portion 410 towards the abutment 312 in a direction along the center axis 412 and pressing the coupling portion 410, including the resilient element 420, into the abutment 312 in the direction along the center axis 412 (see, e.g., FIG. 3C) such that the apparatus 400 and the abutment 312 snap together (e.g., with the resilient element 420 compressed by the inner abutment surface 418 and the inner recess surface 419) with the first and second rigid surfaces 434, 436 pressed against one another (see, e.g., FIG. 3D). In certain implementations, the apparatus 400 and the abutment 312, initially coupled together, can be released (e.g., separated) from one another by moving the coupling portion 410 away from the abutment 312 in a direction along the center axis 412, thereby pulling the coupling portion 410, including the resilient element 420, out of the abutment 312 (see, e.g., FIGS. 3C and 3B) such that the apparatus 400 and the abutment 312 snap apart from one another.

In certain implementations, the coupling portion 410 is configured to release from being coupled to the abutment 312 upon tilting of the apparatus 400 relative to the abutment by a predetermined angle of the center axis 412 (e.g., symmetry axis) relative to the longitudinal axis 340 of the abutment 312. For example, a torque applied to the apparatus 400 while the apparatus 400 is coupled to the abutment 312 can tilt the center axis 412 of the coupling portion 410 to be non-parallel to the longitudinal axis 340 of the abutment 312. Upon the angle between the center axis 412 of the coupling portion 410 and the longitudinal axis 340 of the abutment becoming greater than or equal to a predetermined value (e.g., in a range of 5 degrees to 20 degrees), the resilient element 420 can slide away from the inner abutment surface 418 resulting in the coupling portion 410 snapping away from the abutment 312 but without significant damage to the apparatus 400 and/or the abutment 312. In certain such implementations, the apparatus 400 provides a safety feature by allowing the apparatus 400 to detach from the abutment 312 upon an impact or other force unexpectedly applied to the apparatus 400 (e.g., shock protection).

In certain implementations, the resilient element 420 has an elastically compressible cross-section (e.g., O-ring) which provides a spring force that couples the coupling portion 410 with the abutment 312. For example, FIGS. 3A-3D schematically illustrate a substantially circular and substantially planar resilient element 420 encircling the longitudinal axis 412 of the coupling portion 410 with the resilient element 420 contacting both the coupling portion 410 and the abutment 312 substantially continuously along the resilient element 420. In certain other implementations, the resilient element 420 comprises a substantially planar ring-like portion with two ends spaced from one another with an opening therebetween (e.g., C-clip) such that elastically changing the overall width (e.g., diameter) provides the spring force.

In certain implementations, the spring force of the resilient element 420 can be provided by elastic deformation of the overall shape of the resilient element 420. For example, the resilient element 420 can have a substantially non-circular shape that does not contact both the coupling portion 410 and the abutment 312 substantially continuously along the resilient element 420. The material (e.g., plastic; metal) of the resilient element 420 (e.g., garter spring; C-clip; O-ring) can extend around (e.g., encircle) the longitudinal axis 412 and can have a substantially elliptical or polygonal shape (e.g., substantially triangular; substantially square; substantially pentagonal; substantially hexagonal; substantially heptagonal; substantially octagonal) and/or a wave-like perimeter (e.g., differing radial distances from a center of the resilient element 420 along the perimeter). Examples of such resilient elements 420 are available from Smalley Steel Ring Company of Lake Zurich, Illinois. The resilient element 420 can provide fixation along the axial direction (e.g., along the longitudinal axis 412 of the coupling portion 410 and/or the longitudinal axis 340 of the abutment 312), as well as fixation along the radial direction (e.g., perpendicular to the axial direction).

FIGS. 4A-4C schematically illustrate various cross-sectional views of an example apparatus 400 in accordance with certain implementations described herein. FIG. 4A shows a cross-sectional view of a substantially planar resilient element 420 in a plane substantially perpendicular to the longitudinal axis 412, and FIGS. 4B and 4C show cross-sectional views of the resilient element 420 of FIG. 4A in two different planes substantially perpendicular to the resilient element 420. The resilient element 420 of FIG. 4A is substantially octagonal and has a wave-like perimeter that varies in the radial direction relative to the symmetry axis (e.g., the longitudinal axis 412, the longitudinal axis 340). The resilient element 420 comprises multiple portions 442 configured to contact an outer surface of the coupling portion 410 (e.g., while spaced from the inner surface of the abutment 312) and multiple portions 444 configured to contact an inner surface of the abutment 312 (e.g., while spaced from the outer surface of the coupling portion 410). While the resilient element 420 of FIGS. 4A-4C is substantially planar, in certain other implementations, the resilient element 420 has a substantially non-planar shape (e.g., a wave-like perimeter that varies in the axial direction relative to the symmetry axis).

In certain implementations, the resilient element 420 has a substantially circular cross-section (see, e.g., FIGS. 4B and 4C) in a plane substantially perpendicular to the resilient element 420 with a substantially constant thickness along the circumference of the resilient element 420, while in certain other implementations, the cross-section in a plane substantially perpendicular to the resilient element 420 is non-circular (e.g., rectangular). In certain implementations, the resilient element 420 is configured to fit within grooves of the coupling portion 410 and the abutment 312, and the grooves are configured to facilitate the axial fixation provided by the resilient element 420. For example, the grooves of the coupling portion 410 and/or the abutment 312 can comprise a substantially rectangular cross-section or a V-shaped cross-section (see, e.g., FIGS. 4B and 4C). Other shapes of the grooves are also compatible with certain implementations described herein.

In certain implementations, the substantially non-circular shape of the resilient element 420 has more stiffness than an O-ring of comparable size, and the size, shape, and materials of the resilient element 420 can be optimized for the particular usage. The substantially non-circular shape of the resilient element 420 can allow the coupling portion 410 to be moved into engagement with the abutment 312 at a non-zero angle (e.g., the longitudinal axis 412 of the coupling portion 410 at a non-zero angle relative to the longitudinal axis 340 of the abutment 312), thereby elastically deforming the shape of the resilient element 420, and then rotating the coupling portion 410 so that the longitudinal axis 412 is aligned with the longitudinal axis 340 to snap the coupling portion 410 onto the abutment 312. In this way, the coupling portion 410 can engage the abutment 312 with less force applied than had the coupling portion 410 been moved into engagement with the abutment 312 solely along the longitudinal axes 412, 340.

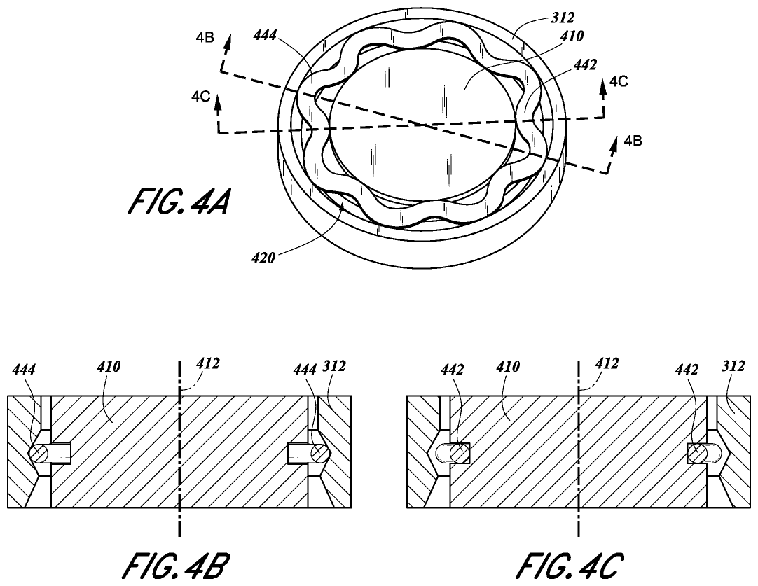

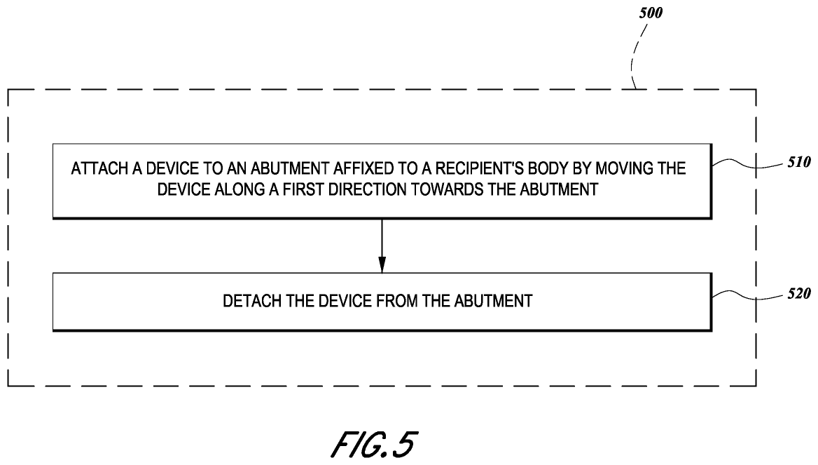

FIG. 5 is a flow diagram of an example method 500 in accordance with certain implementations described herein. While the method 500 is described by referring to some of the structures of the example apparatus 400 of FIGS. 2, 3A-3D, and 4A-4C, other apparatus and systems with other configurations of components can also be used to perform the method 500 in accordance with certain implementations described herein.

In an operational block 510, the method 500 comprises attaching a device (e.g., apparatus 400; coupling portion 410) to an abutment (e.g., abutment 312) affixed to a recipient's body by moving the device along a first direction towards the abutment (e.g., along a center axis of the coupling portion 410) such that a ring-shaped elastically compressible member (e.g., resilient element 420; garter spring; C-clip; O-ring) is compressed between an inner perimeter of the ring-shaped elastically compressible member and an outer perimeter of the ring-shaped elastically compressible member (e.g., the resilient element 420 is in a recess 414 of the device or the abutment and is compressed by respective surfaces of the device and the abutment such that the distance between the inner perimeter and the outer perimeter is reduced). For example, said attaching the device to the abutment is illustrated by the sequence of FIGS. 3B, 3C, and 3D.

In an operational block 520, the method 500 further comprises detaching the device from the abutment. For example, said detaching the device can comprise moving the device along a second direction away from the abutment, the second direction substantially parallel to the first direction (e.g., as illustrated by the sequence of FIGS. 3D, 3C, and 3B).

In certain implementations, after attaching the device to the abutment, but before detaching the device from the abutment, the method 500 further comprises transmitting vibrations from the device to the recipient's body via the abutment. For example, the vibrations can be generated by the device in response to electrical signals indicative of sound detected by at least one microphone (e.g., of the device), received by the auditory system of the recipient via bone conduction, to provide a hearing percept to the recipient.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a nonexclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of various devices, various implementations described herein can be incorporated in a variety of other suitable devices, methods, and contexts. More generally, as can be appreciated, certain implementations described herein can be used in a variety of implantable medical device contexts that can benefit from certain attributes described herein.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein but should be defined only in accordance with the claims and their equivalents.

1. An apparatus comprising:
a coupling portion configured to be releasably coupled to an abutment affixed to a recipient's body, the coupling portion comprising:
a substantially cylindrically symmetric body portion extending along a symmetry axis, the body portion comprising an outer body surface having a recess extending around the symmetry axis; and
a resilient member in the recess and extending around the symmetry axis, the resilient member extending outwardly past the outer body surface and configured to contact an inner abutment surface of the abutment, the resilient member configured to undergo compression by the inner abutment surface and an inner surface of the recess upon being releasably coupled to the abutment, the compression having a component substantially perpendicular to the symmetry axis.

2. The apparatus of claim 1, wherein the resilient member comprises an O-ring, a C-clip, or a garter spring.

3. The apparatus of claim 1, wherein the body portion, the recess, and the resilient member are substantially circularly symmetric about the symmetry axis.

4. The apparatus of claim 1, wherein the coupling portion further comprises a first rigid surface and the abutment comprises a second rigid surface, the coupling portion configured to press the first rigid surface against the second rigid surface with a force generated by the compression of the resilient member.

5. The apparatus of claim 4, wherein the apparatus further comprises an actuator configured to generate vibrations, at least a portion of the vibrations transmitted to the recipient's body via the first rigid surface and the second rigid surface.

6. The apparatus of claim 1, wherein the coupling portion is configured to release from being coupled to the abutment upon tilting of the apparatus relative to the abutment by a predetermined angle.

7. The apparatus of claim 1, wherein the compression of the resilient member reduces a distance between an inner perimeter of the resilient member and an outer perimeter of the resilient member.

8. The apparatus of claim 1, wherein the apparatus comprises an external portion of a percutaneous bone conduction auditory prosthesis.

9. The apparatus of claim 1, wherein the coupling portion comprises a male component and the abutment comprises a female component configured to mate with the male component of the coupling portion, or the coupling portion comprises a female component and the abutment comprises a male component configured to mate with the female component of the coupling portion.

10. The apparatus of claim 1, wherein the resilient member has a substantially non-circular shape.

11. The apparatus of claim 10, wherein the resilient member has a substantially elliptical or polygonal shape and/or a wave-like perimeter varies in the radial direction relative to the symmetry axis and/or the axial direction relative to the symmetry axis.

12. The apparatus of claim 10, wherein the resilient member does not contact both the coupling portion and the abutment substantially continuously along the resilient member.

13. The apparatus of claim 10, wherein the resilient member is configured to fit within grooves of the coupling portion and the abutment.

14. The apparatus of claim 13, wherein the grooves are configured to facilitate axial fixation provided by the resilient member.

15. An apparatus comprising:
a rigid body portion having a center axis and configured to be releasably attached to an abutment affixed to a recipient's body by moving the rigid body portion along the center axis towards the recipient's body, the rigid body portion or the abutment comprising a channel completely encircling the center axis; and
an elastically compressible element in the channel and completely encircling the center axis, the elastically compressible element configured to, upon the rigid body portion being releasably attached to the abutment, apply forces having substantially radial force components to both the rigid body portion and the abutment.

16. The apparatus of claim 15, wherein the elastically compressible element comprises an O-ring, a C-clip, or a garter spring.

17. The apparatus of claim 15, wherein the rigid body portion and the abutment are configured to be snap coupled to one another.

18. The apparatus of claim 15, further comprising a transducer configured to generate vibrational energy, the rigid body portion and the abutment configured to provide a transmission path for the vibrational energy from the transducer to the recipient's body.

19. A method comprising:
attaching a device to an abutment affixed to a recipient's body by moving the device along a first direction towards the abutment such that a ring-shaped elastically compressible member is compressed between an inner perimeter of the ring-shaped elastically compressible member and an outer perimeter of the ring-shaped elastically compressible member; and
detaching the device from the abutment without damaging the device and/or the abutment.

20. The method of claim 19, wherein said detaching comprises moving the device along a second direction away from the abutment.

21. The method of claim 20, wherein the first direction and the second direction are substantially parallel to one another.

22. The method of claim 20, wherein the first direction and the second direction are at a non-zero angle relative to one another.

23. The method of claim 19, wherein the ring-shaped elastically compressible member comprises an O-ring, a C-clip, or a garter spring.

24. The method of claim 23, wherein the ring-shaped elastically compressible member is in a recess of the device or the abutment.

25. The method of claim 19, wherein said detaching comprises applying a torque to the device while the device is attached to the abutment such that an angle between a longitudinal axis of the device and a longitudinal axis of the abutment becomes greater than or equal to a predetermined value.

26. The method of claim 19, further comprising, after attaching the device to the abutment, but before detaching the device from the abutment, transmitting vibrations from the device to the recipient's body via the abutment, the vibrations generated by the device in response to electrical signals indicative of sound detected by at least one microphone of the device.
